(19) United States
(12) Patent Application Publication
(10) Pub. No.: US 2007/0019654 A1
(43) Pub. Date: Jan. 25, 2007

(54) Home network system

(75) Inventors: Sam-Chul Ha, Changwon-Shi, Kyungsangnam-Do (KR); Seung-Myun Baek, Kyungsangnam-do (KR); Koon-Seok Lee, Kyungsangnam-Do (KR); Yong-Tae Kim, Kyungsangnam-Do (KR)

Correspondence Address: MCKENNA LONG & ALDRIDGE LLP, 1900 K STREET, NW, WASHINGTON, DC, 20006, US

(73) Assignee: LG Electronics, Inc., Yougdungpo-Ku, Seoul (KR)

(21) Appl. No.: 10/558,431

(22) PCT Filed: May 14, 2004
(86) PCT No.: PCT/KR04/01150

§ 371 Date: Nov. 29, 2005

(30) Foreign Application Priority Data
May 30, 2003 (KR) 10-2003-0034962
Mar. 31, 2004 (KR) 10-2004-0022187

(51) Int. Cl. H04J 1/16; H04L 12/56

(52) U.S. Cl. 370/400; 370/252

(57) ABSTRACT

The present invention discloses a home network system using a living network control protocol. The home network system includes: an electric device having at least two heterogeneous function means; a network based on a predetermined protocol; and a network manager for controlling and/or monitoring the electric device through the network, the electric device including a packet processing device having one node address provided by the network manager, generating a packet having the node address, transmitting the packet to the network manager, address from the network manager, and enabling the heterogeneous function means corresponding to a command included in the packet to execute the command.

### TECHNICAL FIELD

The present invention relates to a home network system, and more particularly to, a home network system using a living network control protocol.

### BACKGROUND ART

A home network connects various digital home appliances so that the user can always enjoy convenient, safe and economic life services inside or outside the house. Refrigerators or washing machines called white home appliances have been gradually digitalized due to the development of digital signal processing techniques, home appliance operating system techniques and high speed multimedia communication techniques have been integrated on the digital home appliances, and new information home appliances have been developed, to improve the home network.

As shown in Table 1, the home network is classified into a data network, an entertainment network and a living network by types of services.

TABLE 1

| Classification | Function | Service type |
|---|---|---|
| Data network | Network between | Data exchange, Internet |
| | PC and peripheral | service, etc. |
| | devices | |
| Entertainment | Network between | Music, animation |
| network | A/V devices | service, etc. |
| Living network | Network for controlling | Home appliances control, |
| | home appliances | home automation, remote |
| | | meter reading, message |
| | | service, etc. |

Here, the data network is built to exchange data between a PC and peripheral devices or provide an internet service, and the entertainment network is built between home appliances using audio or video information. In addition, the living network is built to simply control home appliances, such as home automation or remote meter reading.

A conventional home network system includes a master device which is an electric device for controlling an operation of the other electric devices or monitoring a status thereof, and a slave device which is an electric device having a function of responding to the request of the master device and a function of notifying a status change according to characteristics of the electric devices or other factors. Exemplary electric devices include home appliances for the living network service such as a washing machine and a refrigerator, home appliances for the data network service and the entertainment network service, and products such as a gas valve control device, an automatic door device and an electric lamp.

However, the conventional arts do not suggest a general communication standard for providing functions of controlling and monitoring electric devices in a home network system.

### DISCLOSURE OF THE INVENTION

The present invention is achieved to solve the above problems. An object of the present invention is to provide a home network system using a control protocol which is a general communication standard for providing functions of controlling and monitoring electric devices having heterogeneous function means in the home network system.

Another object of the present invention is to provide a home network system using a living network control protocol as a general communication standard.

Yet another object of the present invention is to provide electric devices having heterogeneous function means for processing data/packets according to a living network control protocol.

In order to achieve the above-described objects of the invention, there is provided a home network system including: an electric device having at least two heterogeneous function means; a network based on a predetermined protocol; and a network manager for controlling and/or monitoring the electric device through the network, the electric device including a packet processing device having one node address provided by the network manager, generating a packet having the node address, transmitting the packet to the network manager, receiving the packet having the node address from the network manager, and enabling the heterogeneous function means corresponding to a command included in the packet to execute the command.

Preferably, the electric device includes one physical communication interface with the network.

Preferably, the commands are divided according to the heterogeneous function means, and the packet processing device transmits the command to the corresponding heterogeneous function means, so that the heterogeneous function means can execute the command.

Preferably, the packet processing device enables the heterogeneous function means corresponding to the command to execute the command according to characteristics of the command.

Preferably, the protocol is a living network control protocol (LnCP).

Preferably, the packet processing device is a slave device.

Preferably, the packet processing device includes a master device and a slave device.

Preferably, the packet processing device includes a master device, a slave deice and a network management device.

According to one aspect of the present invention, an electric device includes: at least two heterogeneous function means; a communication interface accessing a predetermined protocol for connection to a network manager, and a packet processing device having one node address provided by the network manager, generating a packet having the node address, transmitting the packet to the network manager through the communication interface, receiving the packet having the node address from the network manager through the communication interface, and enabling the heterogeneous function means corresponding to a command included in the packet to execute the command.

According to another aspect of the present invention, a home network system includes: an electric device having at least two heterogeneous function means; a network based on a predetermined protocol; and a network manager for controlling and monitoring the electric device through the network, the electric device including a plurality of packet processing devices each respectively having a node address provided by the network manager corresponding to the heterogeneous function means, generating a packet having the node address, transmitting the packet to the network manager, receiving the packet having the node address from the network manager, and enabling the heterogeneous function means to execute a command included in the packet.

According to yet another aspect of the present invention, an electric device includes: at least two heterogeneous function means; a communication interface accessing a predetermined protocol for connection to a network manager, and a plurality of packet processing devices each respectively having a node address provided by the network manager corresponding to the heterogeneous function means, generating a packet having the node address, transmitting the packet to the network manager, receiving the packet having the node address from the network manager, and enabling the heterogeneous function means to execute a command included in the packet.

### BRIEF DESCRIPTION OF THE DRAWINGS

FIG. 1 is a structure view illustrating a home network system in accordance with the present invention;

FIG. 2 is a structure view illustrating a living network control protocol stack in accordance with the present invention;

FIGS. 3A and 3B are structure views illustrating interfaces between layers of FIG. 2, respectively;

FIGS. 4A to 4F are detailed structure views illustrating the interfaces of FIGS. 3A and 3B, respectively;

FIGS. 5A to 5C are schematic structure views illustrating electric devices in accordance with first to third embodiments of the present invention; and

FIGS. 6Aa and 6B are schematic structure views illustrating electric devices in accordance with fourth and fifth embodiments of the present invention.

### BEST MODE FOR CARRYING OUT THE INVENTION

A home network system in accordance with the present invention will now be described in detail with reference to the accompanying drawings.

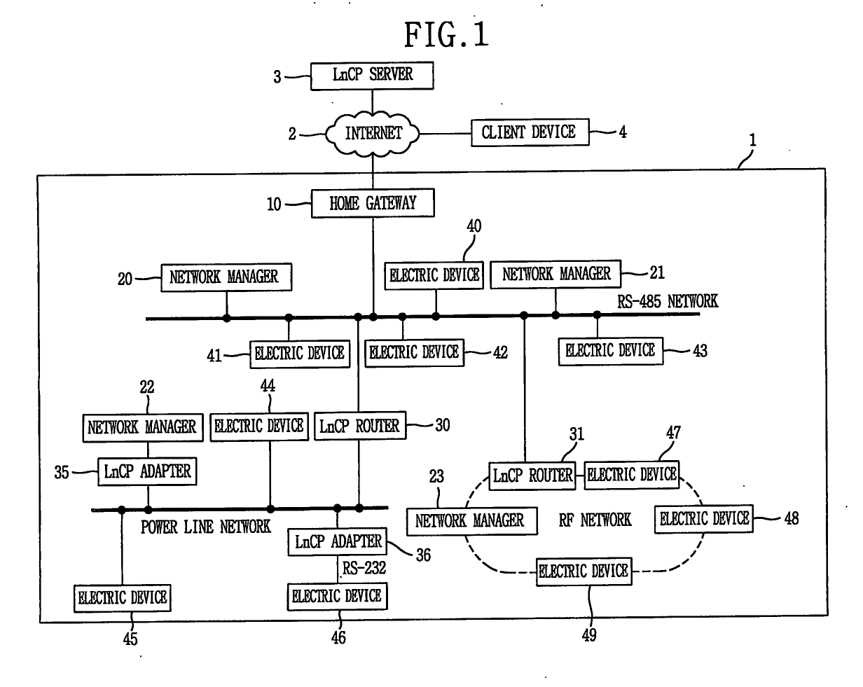

FIG. 1 is a structure view illustrating the home network system in accordance with the present invention.

Referring to FIG. 1, the home network system 1 accesses an LnCP server 3 through an internet 2, and a client device 4 accesses the LnCP server 3 through the internet 2. That is, the home network system 1 is connected to communicate with the LnCP server 3 and/or the client device 4.

An external network of the home network system 1 such as the internet 2 indudes additional constitutional elements according to a kind of the client device 4. For example, when the client device 4 is a computer, the internet 2 includes a Web server (not shown), and when the client device 4 is an internet phone, the internet 2 includes a Wap server (not shown).

The LnCP server 3 accesses the home network system 1 and the client device 4 according to predetermined login and logout procedures, respectively, receives monitoring and control commands from the client device 4, and transmits the commands to the network system 1 through the internet 2 in the form of predetermined types of messages. In addition, the LnCP server 3 receives a predetermined type of message from the home network system 1, and stores the message and/or transmits the message to the client device 4. The LnCP server 3 also stores or generates a message, and transmits the message to the home network system 1. That is, the home network system 1 accesses the LnCP server 3 and downloads provided contents.

The home network system 1 includes a home gateway 10 for performing an access function to the internet 2, network managers 20 to 23 for performing a function of setting an environment and managing electric devices 40 to 49, LnCP routers 30 and 31 for access between transmission media, LnCP adapters 35 and 36 for connecting the network manager 22 and the electric device 46 to the transmission medium, and the plurality of electric devices 40 to 49.

The network of the home network system 1 is formed by connecting the electric devices 40 to 49 through a shared transmission medium. A data link layer uses a non-standardized transmission medium such as RS-485 or small output RF, or a standardized transmission medium such as a power line and IEEE 802.11 as the transmission medium.

The network of the home network system 1 is separated from the internet 2, for composing an independent network for connecting the electric devices through wire or wireless transmission medium. Here, the independent network includes a physically-connected but logically-divided network.

The home network system 1 includes master devices for controlling operations of the other electric devices 40 to 49 or monitoring statuses thereof, and slave devices having functions of responding to the request of the master devices and notifying their status change information. The master devices include the network managers 20 to 23, and the slave devices include the electric devices 40 to 49. The network managers 20 to 23 include information of the controlled electric devices 40 to 49 and control codes, and control the electric devices 40 to 49 according to a programmed method or by receiving inputs from the LnCP server 3 and/or the client device 4. Still referring to FIG. 1, when the plurality of network managers 20 to 23 are connected, each of the network managers 20 to 23 must be both the master device and the slave device, namely physically one device but logically the device (hybrid device) for simultaneously performing master and slave functions in order to perform information exchange, data synchronization and control with the other network managers 20 to 23.

In addition, the network managers 20 to 23 and the electric devices 40 to 49 can be connected directly to the network (power line network, RS-485 network and RF network) or through the LnCP routers 30 and 31 and/or the LnCP adapters 35 and 36.

The electric devices 40 to 49 and/or the LnCP routers 30 and 31 and/or the LnCP adapters 35 and 36 are registered in the network managers 20 to 23, and provided with intrinsic logical addresses by products (for example,0x00, 0x01, etc.). The logical addresses are combined with product codes (for example, 0x02 of air conditioner and 0x01 of washing machine), and used as node addresses. For example, the electric devices 40 to 49 and/or the LnCP routers 30 and 31 and/or the LnCP adapters 35 and 36 are identified by the node addresses such as 0x200 (air conditioner 1) and 0x0201 (air conditioner 2). A group address for identifying at least one electric device 40 to 49 and/or at least one LnCP router 30 and 31 and/or at least one LnCP adapter 35 and 36 at a time can be used according to a predetermined standard (all identical products, installation space of products, user, etc.). In the group address, an explicit group address is a cluster for designating a plurality of devices by setting an address option value (flag mentioned below) as 1, and an implicit group address designates a plurality of devices by filling the whole bit values of the logical addresses and/or the product codes with 1. Especially, the implicit group address is called a cluster code.

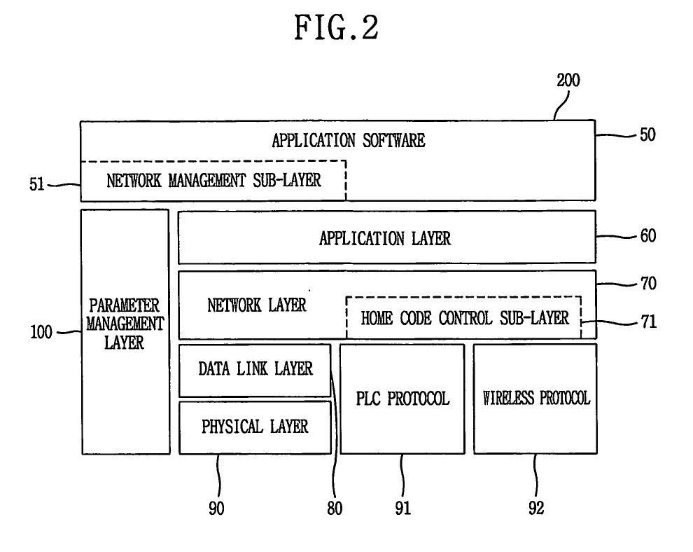

FIG. 2 is a structure view illustrating a living network control protocol stack in accordance with the present invention. The home network system 1 enables the network managers 20 to 23, the LnCP routers 30 and 31, the LnCP adapters 35 and 36 and the electric devices 40 to 49 to communicate with each other according to the living network control protocol (LnCP) of FIG. 2. Therefore, the network managers 20 to 23, the LnCP routers 30 and 31, the LnCP adapters 35 and 36 and the electric devices 40 to 49 perform network communication according to the LnCP.

As illustrated in FIG. 2, the LnCP includes an application software 50 for performing intrinsic functions of the network managers 20 to 23, the LnCP routers 30 and 31, the LnCP adapters 35 and 36 and the electric devices 40 to 49, and providing an interface function with an application layer 60 for remote controlling and monitoring on the network, the application layer 60 for providing services to the user, and also providing a function of forming information or a command from the user in the form of a message and transmitting the message to the lower layer, a network layer 70 for reliably network-connecting the network managers 20 to 23, the LnCP routers 30 and 31, the LnCP adapters 35 and 36 and the electric devices 40 to 49, a data link layer 80 for providing a medium access control function of accessing a shared transmission medium, a physical layer 90 for providing physical interfaces between the network managers 20 to 23, the LnCP routers 30 and 31, the LnCP adapters 35 and 36 and the electric devices 40 to 49, and rules for transmitted bits, and a parameter management layer 100 for setting and managing node parameters used in each layer.

In detail, the application software 50 further includes a network management sub-ayer 51 for managing the node parameters, and the network managers 20 to 23, the LnCP routers 30 and 31, the LnCP adapters 35 and 36 and the electric devices 40 to 49 which access the network. That is, the network management sub-layer 51 performs a parameter management function of setting or using the node parameter values through the parameter management layer 100, and a network management function of composing or managing the network when the device using the LnCP is a master device.

When the network which the network managers 20 to 23, the LnCP routers 30 and 31, the LnCP adapters 35 and 36 and the electric devices 40 to 49 access is a dependent transmission medium such as a power line, IEEE 802.11 and wireless (for example, when the LnCP includes a PLC protocol and/or wireless protocol), the network layer 70 further includes a home code control sub-layer 71 for performing a function of setting, managing and processing home codes for logically dividing each individual network. When the individual networks are physically divided by an independent transmission medium such as RS-485, the home code control sub-layer 71 is not included in the LnCP. Each of the home codes is comprised of 4 bytes, and set as random values or designated values of the user.

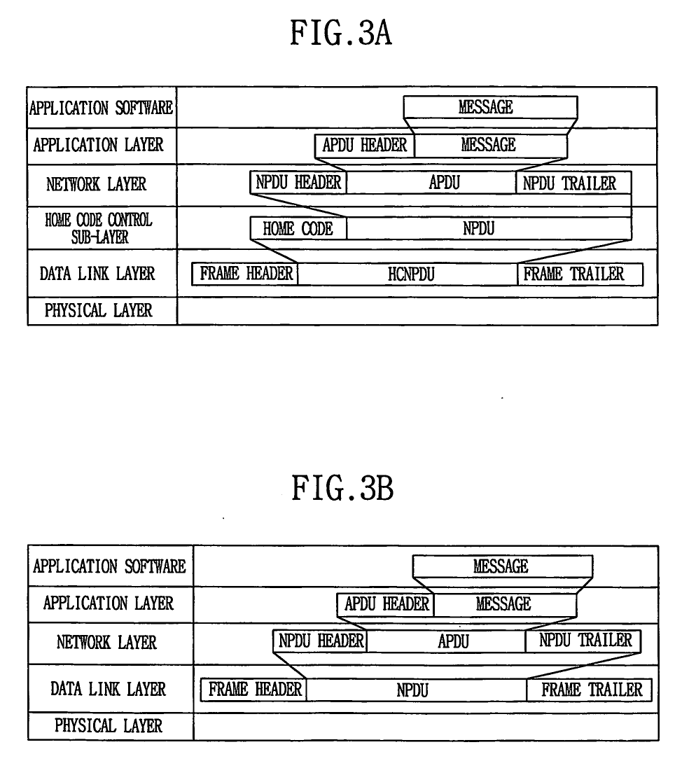

FIGS. 3A and 3B are structure views illustrating interfaces between the layers of FIG. 2, respectively.

FIG. 3A illustrates the interfaces between the layers when the physical layer 90 is connected to the dependent transmission medium, and FIG. 3B illustrates the interfaces between the layers when the physical layer 90 is connected to the independent transmission medium.

The home network system 1 adds headers and trailers required by each layer to protocol data units (PDU) from the upper layers, and transmit them to the lower layers.

As shown in FIGS. 3A and 3B, an application layer PDU (APDU) is a data transmitted between the application layer 60 and the network layer 70, a network layer PDU (NPDU) is a data transmitted between the network layer 70 and the data link Layer 80 or the home code control sub-layer 71, and a home code control sub-layer PDU (HCNPDU) is a data transmitted between the network layer 70 (precisely, the home code control sub-layer 71) and the data link layer 80. The interface is formed in data frame units between the data link layer 80 and the physical layer 90.

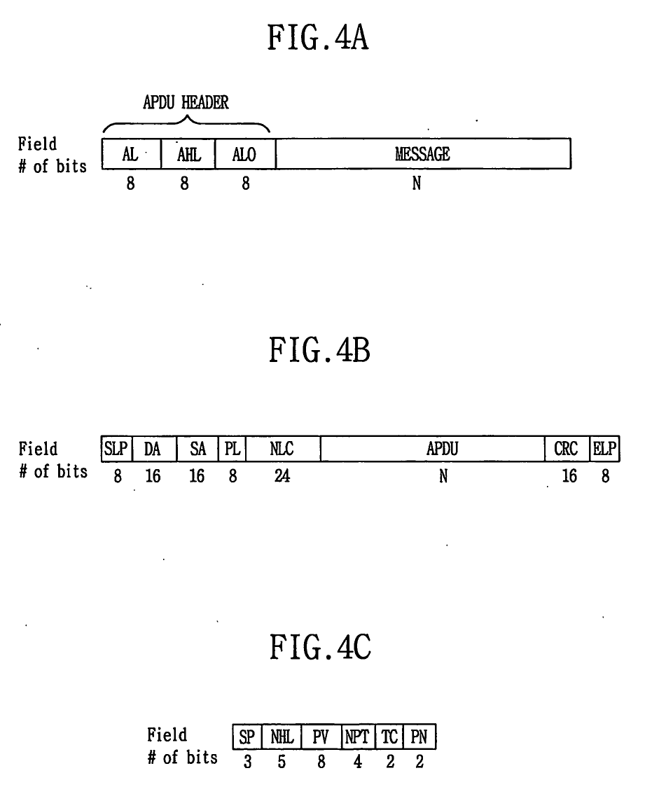

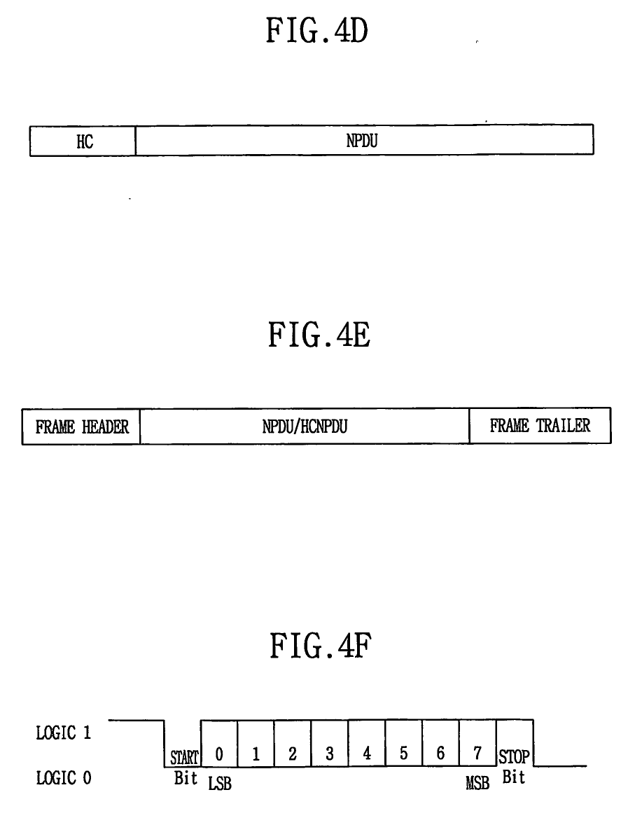

FIGS. 4A to 4F are detailed structure views illustrating the interfaces of FIGS. 3A and 3B, respectively.

FIG. 4A illustrates the APDU structure in the application layer 60.

An APDU length (AL) field shows a length of the APDU (length from AL to message field), and has a minimum value of 4 and a maximum value of 77 .

An APDU header length (AHL) field shows a length of an APDU header (length from AL to AL 0), normally has 3 bytes, and is extensible to 7 bytes. In the LnCP, the APDU header can be extended to 7 bytes to encode a message field and change an application protocol.

An application layer option (ALO) field extends a message set For example, when the ALO field is set as 0, if the ALO field contains a different value, message processing is ignored.

The message field processes a control message from the user or event information, and is changed by the value of the ALO field.

FIG. 4B illustrates the NPDU structure in the network layer 70, and FIG. 4C illustrates a detailed NLC structure of the NPDU.

A start of LnCP packet (SLP) field shows start of a packet and has a value of 0x02.

Destination address (DA) and source address (SA) fields are node addresses of a receiver and a sender of a packet, and have 16 bits, respectively. The most significant 1 bit includes a flag indicating a group address, the succeeding 7 bits include a kind of a product (product code), and the lower 8 bits include a logical address for distinguishing the plurality of network managers 20 to 23 of the same kind and the plurality of electric devices 40 to 49 of the same kind.

A packet length (PL) field shows the whole length of the NPDU, and has a minimum value of 12 bytes and a maximum value of 100 bytes.

A service priority (SP) field gives transmission priority to a transmission message and has 3 bits. Table 2shows the priority of each transmission message.

When a slave device responds to a request of a master device, the slave device takes the priority of the request message from the master device.

TABLE 2

| Priority | Value | Application layer |
|---|---|---|
| High | 0 | When an urgent message is transmitted |
| Middle | 1 | When a normal packet is transmitted |
| | | When an event message for online or offline status |
| | | change is transmitted |
| Normal | 2 | When a notification message for composing a network |
| | | is transmitted |
| | | When a normal event message is transmitted |
| Low | 3 | When a data is transmitted by download |
| | | or upload mechanism |

An NPDU header length (NHL) field extends an NPDU header (NLC field of SLP), normally has 9 bytes, and is extensible maximally to 16 bytes.

A protocol version (PV) field is an one-byte field showing a version of a used protocol. The upper 4 bits include a version field and the lower 4 bits include a sub-version field. The version and the sub-version are represented by the hexadecimal, respectively.

A network layer packet type (NPT) field is a 4-bit field for distinguishing a kind of a packet in the network layer 70. The LnCP includes a request packet, a response packet and a notification packet. The NPT field of a master device must be set as the request packet or the notification packet, and the NPT field of a slave device must be set as the response packet or the notification packet. Table 3 shows NPT values by kinds of packets.

TABLE 3

| Explanation | Value |
|---|---|
| Request packet | 0 |
| Not used | 1-3 |
| Response packet | 4 |
| Not used | 5-7 |
| Notification packet | 8 |
| Not used | 9-12 |
| Reserved value for interface with the home code | 13-15 |
| control sub-layer | |

A transmission counter (TC) field is a 2-bit field for retrying a request packet when the request packet or response packet is not successfully transmitted due to a communication error in the network layer 70, or repeatedly transmitting a notification packet to improve a transmission success ratio. A receiver can check a duplicate message by using a value of the TC field. Table 4 shows the range of the values of the TC field by the NPT values.

TABLE 4

| Kind of packet | Value (range) |
|---|---|
| Request packet | 1-3 |
| Response packet | 1 |
| Notification packet | 1-3 |

A packet number (PN) field has 2 bits, and is used to check a duplicate packet in a slave device with the TC field and process a plurality of communication cycles in a master device. Table 5 shows the range of the values of the PN field by the NPT values.

TABLE 5

| Kind of packet | Value (range) |
|---|---|
| Request packet | 0-3 |
| Response packet | Copy a PN field value of a request packet |
| Notification packet | 0-3 |

An APDU field is a protocol data unit of the application layer 60 transmitted between the application layer 60 and the network layer 70. The APDU field has a minimum value of 0 byte and a maximum value of 88 bytes.

A cyclic redundancy check (CRC) field is a 16-bit field for checking an error of a received packet (from SLP to APDU).

An end of LnCP packet (ELP) field shows end of a packet and has a value of 0x03. Although a data corresponding to the length of the PL field is received, if the ELP field is not checked, it is deemed to be a packet error.

FIG. 4D illustrates the HCNPDU structure in the home code control sub-layer 71.

As depicted in FIG. 4D, a home code (HC) field is added to the upper portion of the NPDU.

The home code is comprised of 4 bytes, and has a unique value within the line distance where a packet can be transmitted.

FIG. 4E illustrates a frame structure in the data link layer 80.

The structure of the header and the trailer of the data link layer frame of the LnCP is changed according to transmission media. When the data link layer 80 uses a non-standardized transmission medium, the header and the trailer of the frame must have null fields, and when the data link layer 80 uses a standardized transmission medium, the header and the trailer of the frame are formed as prescribed by the protocol. An NPDU field is a data unit transmitted from the upper network layer 70, and an HCNPDU field is a data unit obtained by adding 4 bytes of home code to the front portion of the NPDU, when the physical layer 90 is a dependent transmission medium such as a power line or IEEE 802.11. The data link layer 80 processes the NPDU and the HCNPDU in the same manner.

FIG. 4F illustrates a frame structure in the physical layer 90.

The physical layer 90 of the LnCP handles a function of transmitting and receiving a physical signal to a transmission medium. The data link layer 80 can use a non-standardized transmission medium such as RS-485 or small output RF or a standardized transmission medium such as a power line or IEEE. 802.11 as the physical layer 90 of the LnCP. The home network system 1 using the LnCP employs a universal asynchronous receiver and transmitter (UART) frame structure and a signal level of RS-232, so that the network managers 20 to 23 and the electric devices 40 to 49 can interface with RS-485, the LnCP routers 30 and 31 or the LnCP adapters 35 and 36. When the UART is connected between the devices by using a serial bus, the UART controls flow of bit signals on a communication line. In the LnCP, a packet from the upper layer is converted into 10 bits of UART frame unit as shown in FIG. 4f, and transmitted through the transmission medium. The UART frame includes one bit of start bit, 8 bits of data and one bit of stop bit, and does not use a parity bit. The UART frame is transmitted in the order of the start bit to stop bit. When the home network system 1 using the LnCP employs the UART, it does not have additional frame header and frame trailer.

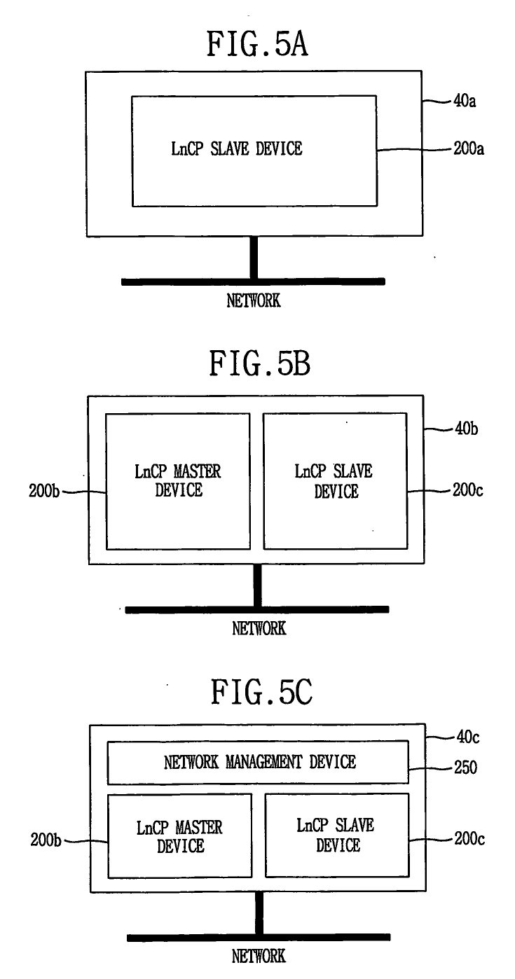

FIGS. 5A to 5C are schematic structure views illustrating electric devices 40a, 40b and 40c in accordance with first to third embodiments of the present invention. Each of the electric devices 40a, 40b and 40c has a single function.

Referring to FIG. 5A, the electric device 40a stores one node address provided by the network manager 20, 21, 22 or 23 in a predetermined storage means (not shown). The electric device 40a includes an LnCP slave device 200a. Here, the LnCP slave device 200a is a means having the aforementioned LnCP and processing a data/packet according to the LnCP. The LnCP slave means 200a is stored in the storage means in the form of software, or built in the electric device 40a in the form of middleware or hardware, and controlled by a central processing means (not shown) of the electric device 40a.

The LnCP slave device 200a generates a packet having the node address by the central processing means, and transmits the packet to the network managers 20 to 23. In addition, the LnCP slave device 200a performs a slave function of receiving the packet having the node address corresponding to the electric device 40a from the network managers 20 to 23, reading a command from the packet, and executing the command.

The electric device 40a is a product for performing one slave function. For example, a lighting apparatus only includes one slave device 200a to be controlled by the network managers 20 to 23.

As illustrated in FIG. 5B, the electric device 40b includes an LnCP master device 200b and an LnCP slave device 200c. The basic structure of the LnCP slave device 200c is identical to that of the LnCP slave device 200a.

In detail, the LnCP master device 200b performs a master function, and the LnCP slave device 200c performs a slave function. The electric device 40b is a hybrid device for performing the master function and the slave function. The electric device 40b, for example, an air conditioner includes the LnCP master device 200b programmed to control windows in the initial operation (function of individually operating a window control device (not shown) according to a predetermined program), and the LnCP slave device 200c to be controlled by the network managers 20 to 23.

As shown in FIG. 5C, the electric device 40c includes the LnCP master device 200b and the LnCP slave device 200c of FIG. 5B, and further includes a network management device 250 for managing the other electric devices. That is, the electric device 40c includes one master device and one slave device, and embodies the whole network management functions, such as the network managers 20 to 23.

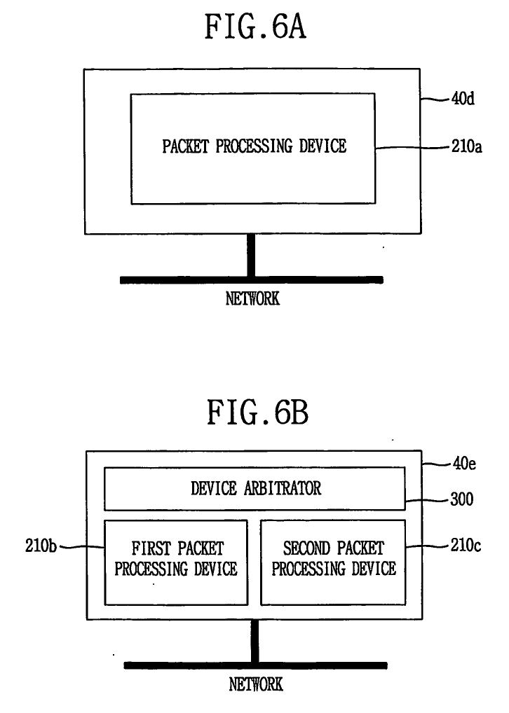

FIGS. 6A and 6B are schematic structure views illustrating electric devices 40d and 40e in accordance with fourth and fifth embodiments of the present invention.

The electric devices 40d and 40e have a common function of processing data/packets among various characteristics of the electric devices 40 to 49. However, each of the electric devices 40d and 40e includes heterogeneous function means having different functions. For example, the heterogeneous function means indicate a microwave oven function and a hood function. Each of the electric devices 40d and 40e uses the heterogeneous function means in a single product, and includes one physical communication interface with a network. Here, the network includes at least a serial interface.

As depicted in FIG. 6A, the electric device 40d stores one node address provided by the network manager 20, 21, 22 or 23 in a predetermined storage means (not shown). The electric device 40d includes one packet processing device 210a and a plurality of heterogeneous function means (not shown). Here, the packet processing device 210a is a means having the aforementioned LnCP and processing a data/packet according to the LnCP. The packet processing device 210a is stored in the storage means in the form of software, or built in the electric device 40d in the form of middleware or hardware, and controlled by a central processing means (not shown) of the electric device 40d.

The packet processing device 210a generates a packet having the node address by the central processing means, and transmits the packet to the network managers 20 to 23. In addition, the packet processing device 210a receives the packet having the node address corresponding to the electric device 40d from the network managers 20 to 23, reads a command from the packet, and enables the heterogeneous function means corresponding to the command to execute the command.

The packet processing device 210a can be embodied by using the LnCP slave device 200a of FIG. 5A, the LnCP master device 200b and the LnCP slave device 200c of FIG. 5B, or the LnCP master device 200b, the LnCP slave device 200c and the network management device 250 of FIG. 5C.

Here, the command is processed by the packet processing device 210a according to the following two methods.

First, the commands are divided according to the heterogeneous function means, and the packet processing device 210a processes the divided commands. For example, when the heterogeneous function means include a microwave oven function and a hood function, commands 0 to 99 are preset in a first command region belonging to the microwave oven function, and commands 100 to 199 are preset in a second command region belonging to the hood function. In this case, the packet processing device 210a reads a command included in the packet, and transmits the command to the heterogeneous function means corresponding to the command region of the read command or the central processing means, so that the heterogeneous function means corresponding to the command can execute the command.

Second, the command has intrinsic characteristics, and the packet processing device 210a enables the heterogeneous function means corresponding to the command to execute the command according to the characteristics of the command. For example, when the command read by the packet processing device 210a is ‘5 minute thawing’, the thawing function belongs to the microwave oven function, and thus the packet processing device 210a transmits the command to the heterogeneous function means corresponding to the command or the central processing means, so that the heterogeneous function means can execute the command.

As illustrated in FIG. 6B, the electric device 40e stores a plurality of node addresses provided by the network manager 20, 21, 22 or 23 in a predetermined storage means (not shown). The number of the node addresses corresponds to the number of heterogeneous function means built in the electric device 40e. The electric device 40e includes two packet processing devices 210b and 210c. The number of the packet processing devices 210b and 210c corresponds to the number of the built-in heterogeneous function means (two kinds in this embodiment). Here, the first and second packet processing devices 210b and 210c are means having the aforementioned LnCP and processing data/packets according to the LnCP. The first and second packet processing devices 210b and 210c are stored in a storage means in the form of software, or built in the electric device 40e in the form of middleware or hardware, and controlled by a central processing means (not shown) of the electric device 40e.

Each of the first and second packet precessing devices 210b and 210c generates a packet having the node address by the central processing means, and transmits the packet to the network managers 20 to 23. In addition, each of the first and second packet processing devices 210b and 210c receives the packet having the node address from the network managers 20 to 23, reads a command from the packet, and enables the heterogeneous function means corresponding to the command to execute the command. Here, the command is processed by the first and second packet processing devices 210b and 210c according to the above-described two methods.

The electric device 40e includes one physical communication interface with a network, and further includes a device arbitrator 300 for enabling the first and second packet processing devices 210b and 210c to share the network. The device arbitrator 300 is also controlled by the central processing means of the electric device 40e, and stored in a predetermined storage means as software, or built in as middleware or hardware.

The device arbitrator 300 confirms the status of the first and second packet processing devices 210b and 210c. While one of the first and second packet processing devices 210b and 210c transmits a predetermined packet, the device arbitrator 300 makes the other packet processing device 210b or 210c stop operation or merely receive a packet. As a result, the device arbitrator 300 prevents packet conflict from occurring because the plurality of packet processing devices 210b and 210c simultaneously transmit packets, and allows the first and second packet processing devices 210b and 210c to efficiently share the network.

Here, each of the first and second packet processing devices 210b and 210c can be embodied by using the LnCP slave device 200a of FIG. 5A, the LnCP master device 200b and the LnCP slave device 200c of FIG. 5B, or the LnCP master device 200b, the LnCP slave device 200c and the network management device 250 of FIG. 5C.

As discussed earlier, the present invention provides the home network system using the control protocol which is the general communication standard for providing the functions of controlling and monitoring the electric devices having the heterogeneous function means in the home network system.

In addition, the present invention provides the home network system using the LnCP as the general communication standard.

Furthermore, the present invention provides the electric devices having the heterogeneous function means for processing data/packets according to the LnCP.

The present invention also shares one network connected to the electric device having the heterogeneous function means.

Although the preferred embodiments of the present invention have been described, it is understood that the present invention should not be limited to these preferred embodiments but various changes and modifications can be made by one skilled in the art within the spirit and scope of the present invention as hereinafter claimed.

What is claimed is:

1. A home network system, comprising:
an electric device having at least two heterogeneous function means;
a network based on a predetermined protocol; and
a network manager for controlling and/or monitoring the electric device through the network, the electric device including a packet processing device having one node address provided by the network manager, generating a packet having the node address, transmitting the packet to the network manager, receiving the packet having the node address from the network manager, and enabling the heterogeneous function means corresponding to a command included in the packet to execute the command.

2. The system of claim 1, wherein the electric device comprises one physical communication interface with the network.

3. The system of claim 1, wherein the commands are divided according to the heterogeneous function means, and the packet processing device transmits the command to the corresponding heterogeneous function means, so that the heterogeneous function means can execute the command.

4. The system of claim 1, wherein the packet processing device enables the heterogeneous function means corresponding to the command to execute the command according to characteristics of the command.

5. The system of claim 1, wherein the protocol is a living network control protocol (LnCP).

6. The system of any one of claims 1 to 5, wherein the packet processing device is a slave device.

7. The system of any one of claims 1 to 5, wherein the packet processing device comprises a master device and a slave device.

8. The system of any one of claims 1 to 5, wherein the packet processing device comprises a master device, a slave deice and a network management device.

9. An electric device, comprising:
at least two heterogeneous function means;
a communication interface accessing a predetermined protocol for connection to a network manager; and
a packet processing device having one node address provided by the network manager, generating a packet having the node address, transmitting the packet to the network manager through the communication interface, receiving the packet having the node address from the network manager through the communication interface, and enabling the heterogeneous function means corresponding to a command included in the packet to execute the command.

10. The electric device of claim 9, wherein the commands are divided according to the heterogeneous function means, and the packet processing device transmits the command to the corresponding heterogeneous function means, so that the heterogeneous function means can execute the command.

11. The electric device of claim 9, wherein the packet processing device enables the heterogeneous function means corresponding to the command to execute the command according to characteristics of the command.

12. The electric device of claim 9, wherein the protocol is a living network control protocol (LnCP).

13. The electric device of any one of claims 9 to 12, wherein the packet processing device is a slave device.

14. The electric device of any one of claims 9 to 12, wherein the packet processing device comprises a master device and a slave device.

15. The electric device of any one of claims 9 to 12, wherein the packet processing device comprises a master device, a slave deice and a network management device.

16. A home network system, comprising:
an electric device having at least two heterogeneous function means;
a network based on a predetermined protocol; and
a network manager for controlling and monitoring the electric device through the network, the electric device including a plurality of packet processing devices each respectively having a node address provided by the network manager corresponding to the heterogeneous function means, generating a packet having the node address, transmitting the packet to the network manager, receiving the packet having the node address from the network manager, and enabling the heterogeneous function means to execute a command included in the packet.

17. The system of claim 16, wherein the number of the packet processing devices corresponds to the number of the heterogeneous function means.

18. The system of claim 16, wherein the electric device comprises one physical communication interface with the interface.

19. The system of claim 18, wherein the electric device further comprises a device arbitrator for enabling the packet processing devices to share the physical communication interface.

20. The system of claim 19, wherein the device arbitrator confirms the status of the packet processing devices, and makes the other packet processing devices stop operations or merely receive packets when one of the packet processing devices transmits a predetermined packet.

21. The system of claim 16, wherein the protocol is a living network control protocol (LnCP).

22. The system of any one of claims 16 to 21, wherein the packet processing device is a slave device.

23. The system of any one of claims 16 to 21, wherein the packet processing device comprises a master device and a slave device.

24. The system of any one of claims 16 to 21, wherein the packet processing device comprises a master device, a slave deice and a network management device.

25. An electric device, comprising:
at least two heterogeneous function means;
a communication interface accessing a predetermined protocol for connection to a network manager, and
a plurality of packet processing devices each respectively having a node address provided by the network manager corresponding to the heterogeneous function means, generating a packet having t he n ode address, transmitting the packet to the network manager, receiving the packet having the node address from the network manager, and enabling the heterogeneous function means to execute a command included in the packet.

26. The electric device of claim 25, wherein the number of the packet processing devices corresponds to the number of the heterogeneous function means.

27. The electric device of claim 25, further comprising a device arbitrator for enabling the packet processing devices to share the communication interface.

28. The electric device of claim 27, wherein the device arbitrator confirms the status of the packet processing devices, and makes the other packet processing devices stop operations or merely receive packets when one of the packet processing devices transmits a predetermined packet.

29. The electric device of claim 25, wherein the protocol is a living network control protocol (LnCP).

30. The electric device of any one of claims 25 to 29, wherein the packet processing device is a slave device.

31. The electric device of any one of claims 25 to 29, wherein the packet processing device comprises a master device and a slave device.

32. The electric device of any one of claims 25 to 29, wherein the packet processing device comprises a master device, a slave deice and a network management device.
